(19) United States
(12) Patent Application Publication
(10) Pub. No.: US 2025/0264040 A1
(43) Pub. Date: Aug. 21, 2025

(54) AXIALLY ADJUSTABLE INSERTED RING AND METHOD OF USING SAME

(71) Applicant: GE Infrastructure Technology LLC, Greenville, SC (US)

(72) Inventors: Steven Sebastian Burdgick, Schenectady, NY (US); Mark W. Kowalczyk, Amsterdam, NY (US); John M. Sassatelli, Valley Falls, NY (US)

(21) Appl. No.: 18/581,535

(22) Filed: Feb. 20, 2024

(51) Int. Cl. F01D 25/24; F01D 11/00

(52) U.S. Cl. CPC F01D 25/246; F01D 11/003; F05D 2230/644; F05D 2240/55

(57) ABSTRACT

A turbine assembly including a casing and a turbine stationary component radially inward from the casing. The casing and the turbine stationary component define a steam joint therebetween. The turbine stationary component defines a groove open to the steam joint, the turbine stationary component defines a first seal face within the groove and opposite from the portion open to the steam joint, and a second seal face within the groove and adjacent to the first seal face, the turbine assembly including an inserted ring. The inserted ring includes a body including a first face, positioned in close proximity to the first seal face of the turbine stationary component, a second face adjacent to the first face and positioned in close proximity to the second seal face of the turbine stationary component, and a third face opposite from the first face and positioned in close proximity to the casing.

### BACKGROUND OF THE INVENTION

The present disclosure relates generally to an inserted ring used in rotating machinery and, more particularly, relates to methods of adjusting such inserted rings in the axial direction.

Rotary machines, such as steam and gas turbines used for power generation and mechanical drive applications, are generally large machines that include multiple turbine stages. High-pressure fluid flowing through these stages must pass through a series of adjoining stationary and rotating components. Seals between the stationary and the rotating components are used to control fluid leakage.

Over time, the stationary and the rotating components, for example, a diaphragm, may require refurbishment and/or replacement to enable the associated rotary machine to continue to operate efficiently. The refurbishment can include, but is not limited to, repairing the diaphragm seal face. This is typically referred to as the “steamface” or “seal face”, which is located between the diaphragm and the casing axial downstream interface. Presently, frequently the component requiring refurbishment must be removed from operation to enable it to be analyzed and/or repaired as necessary. However, removing the component from operation costs time and money, especially in the power generation industry where an outage is often further penalized and may require replacement power to be purchased, for example.

Accordingly, there exists a need for a method of refurbishing a component used in rotating machinery, wherein the method efficient and facilitates limiting downtime of the rotating machinery.

### BRIEF DESCRIPTION OF THE INVENTION

In one aspect, an inserted ring for a turbine assembly, wherein the turbine assembly includes a casing and a turbine stationary component radially inward from the casing such that the casing and the turbine stationary component define a steam joint therebetween. The inserted ring includes a first face positioned adjacent to the casing; and a second face positioned in close proximity to the turbine stationary component such that the second face is spaced a distance from and opposite to the first face, wherein the inserted ring has an axial width defined by the first and second faces.

In another aspect, a turbine assembly includes a casing and a turbine stationary component radially inward from the casing such that the casing and the turbine stationary component define a steam joint therebetween. The turbine stationary component defines a groove open to the steam joint. The turbine stationary component defines a first seal face within the groove and opposite from the portion open to the steam joint, and a second seal face within the groove and adjacent to the first seal face. The turbine assembly includes an inserted ring, which includes a body including a first face, a second face adjacent to the first face, and a third face opposite from the first face. The first face is positioned in close proximity to the first seal face of the turbine stationary component, the second face is positioned in close proximity to the second seal face of the turbine stationary component, and the third face is positioned in close proximity to the casing.

In yet another aspect, a method for selectively positioning an inserted ring relative to a turbine assembly that includes a casing and a turbine stationary component positioned radially inwardly from the casing such that the casing and the turbine stationary component define a steam joint therebetween. The method includes identifying a seal position required at a packing seal location and identifying an axial width defined between a first seal face of the turbine stationary component and a radially inner surface of the casing. The method includes selecting an inserted ring having an axial width that is approximately the same as the axial width identified between the first seal face of the turbine stationary component and the radially inner surface of the casing. The method includes inserting the inserted ring at least partially within a groove defined circumferentially within the turbine stationary component. The method includes fixedly securing the inserted ring within the turbine stationary component groove to facilitate improving the operating efficiency of the turbine assembly.

### BRIEF DESCRIPTION OF THE DRAWINGS

FIG. 1 is a prior art cross-sectional illustration of a portion of a steam turbine assembly;

FIG. 2 is a cross-sectional illustration of a portion of an exemplary steam turbine assembly including an inserted ring;

FIG. 3 is a cross-sectional illustration of a portion of another exemplary steam turbine assembly including an inserted ring;

FIG. 4 is an enlarged cross-sectional view of the steam turbine assembly shown in FIG. 3 and taken within detail 1;

FIG. 5 is an enlarged cross-sectional illustration of an exemplary diaphragm outer ring that may be used with the steam turbine assembly shown in FIG. 3;

FIG. 6 is an enlarged cross-sectional illustration of an exemplary inserted ring that may be used with the steam turbine assembly shown in FIG. 3;

FIG. 7 is a cross-sectional illustration of an exemplary steam turbine assembly including an inserted ring;

FIG. 8 is a top schematic illustration of the exemplary steam turbine assembly including a plurality of inserted rings as shown in FIG. 2;

FIG. 9 is a flow chart illustrating an exemplary method that may be implemented to identify and insert an inserted ring into a steam turbine assembly, such as the steam turbine assembly shown in FIGS. 3 and 7;

FIG. 10 is a cross-sectional illustration of another exemplary steam turbine assembly including an angled inserted ring and a packing material; and

FIG. 11 is a cross-sectional illustration of a further alternative exemplary steam turbine assembly including an inserted plate.

### DETAILED DESCRIPTION OF THE INVENTION

The embodiments described herein relate to systems and methods that enable axial adjustment of an inserted ring/plate used in rotating machinery. At least some of the advantages of the systems described herein, over the prior art, include, at least: (i) selective adjustments of the axial position of the inserted ring/plate; (ii) incremental adjustments of the inserted ring/plate for ease of repair; (iii) reduced downtime of the rotating machinery; and (iv) reduced analysis required to select an appropriate inserted ring/plate based on a determined axial width between components of the rotating machinery.

When introducing elements of various embodiments disclosed herein, the articles “a,” “an,” “the,” and “said” are intended to mean that there are one or more of the elements. The terms “comprising,” “including,” and “having” are intended to be inclusive and mean that there may be additional elements other than the listed elements.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

As used herein, spatially relative terms, such as “beneath”, “below”, “lower”, “above”, “upper”, “front”, “back”, “side”, “left”, “right”, “rear”, “top”, “bottom”, and the like, are used for ease of description to describe one element or feature's relationship to another element(s) or feature(s). It is further understood that the terms “front”, “back”, “left”, and “right” are not intended to be limiting and are intended to be interchangeable, where appropriate. Further, it should be noted that the terms “first,” “second,” and the like herein do not denote any order, quantity, or relative importance, but rather are used to distinguish one element from another.

All methods described herein can be performed in any suitable order unless otherwise indicated herein or otherwise clearly contradicted by context. The use of any and all examples, or exemplary language (e.g., “such as”), is intended merely to better illustrate the invention and does not pose a limitation on the scope of the invention or any embodiments unless otherwise claimed.

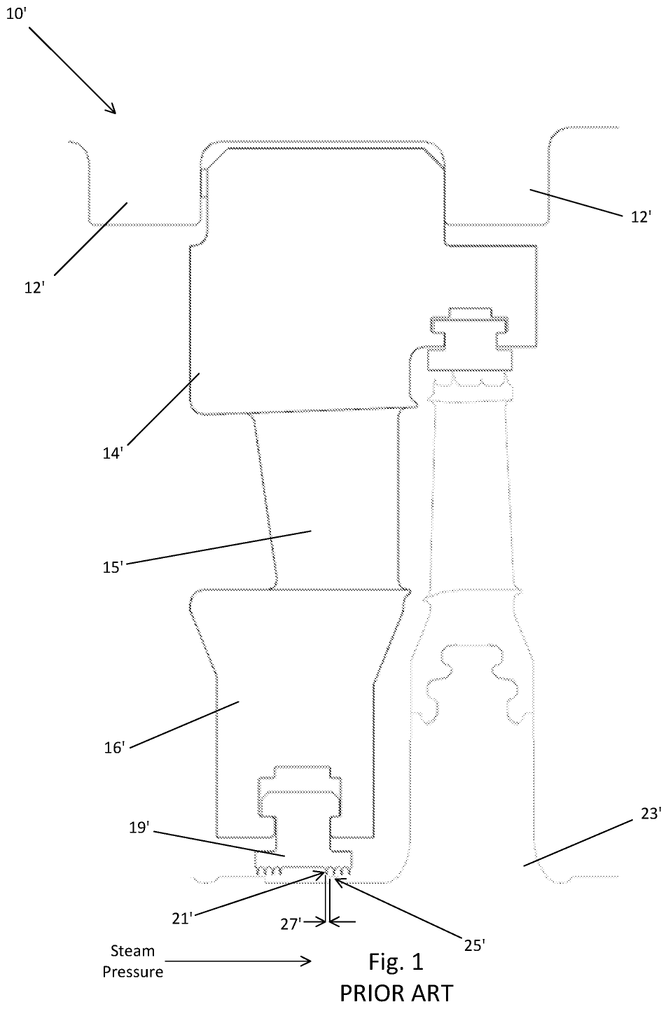

FIG. 1 is a cross-sectional schematic view of a prior art version of a steam turbine assembly 10′. The steam turbine assembly 10′ includes a casing 12′ and a diaphragm outer ring 14′ positioned relative to the casing 12′. The steam turbine assembly 10′ includes a nozzle 15′ and an inner ring 16′ positioned in proximity to the diaphragm outer ring 14′. The steam turbine assembly 10′ includes a packing ring 19′ that is positioned in proximity to the inner ring 16′. The packing ring 19′ defines one or more protrusions 21′ that extend outwardly and in the direction of opposing protrusions 25′ of a rotor 23′.

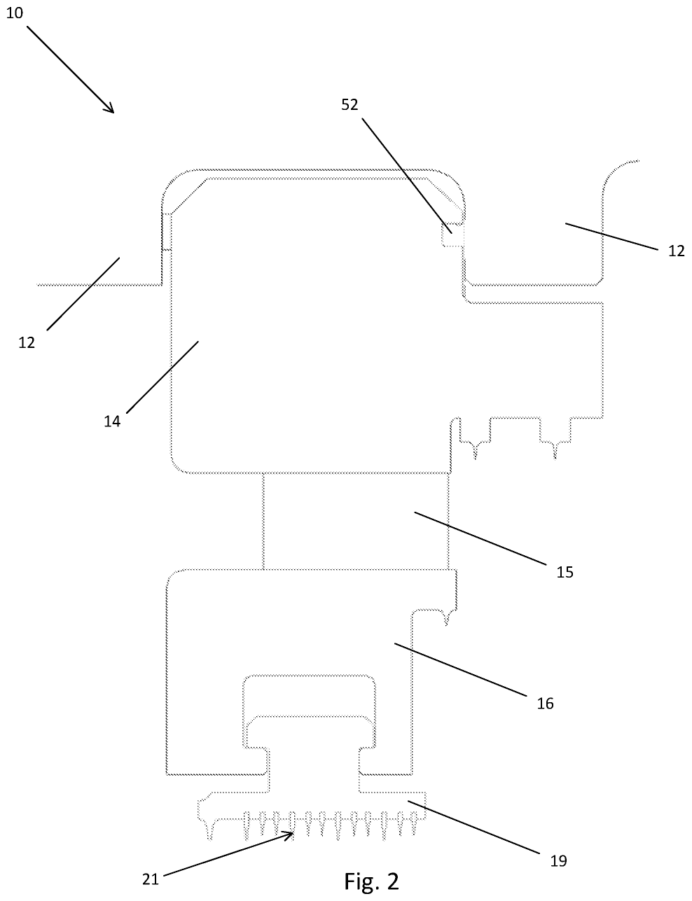

FIG. 2 is a cross-sectional schematic view of an exemplary steam turbine assembly 10. In the exemplary embodiment, assembly 10 includes a casing 12 and a turbine stationary component 14 positioned relative to the casing 12. The turbine stationary component 14 may include, but is not limited to, a diaphragm outer ring, a packing head, a packing ring, a packing carrier, an oil deflector, and/or variations thereof. The steam turbine assembly 10 includes a nozzle 15 and an inner ring 16 positioned in proximity to the diaphragm outer ring 14. More specifically, the nozzle 15 is between the diaphragm outer ring 14 and the inner ring 16. The steam turbine assembly 10 includes a packing ring 19 that is positioned in proximity to the inner ring 16. The packing ring 19 incudes protrusions 21 that extend outwardly from the packing ring 19. The protrusions correlate with the protrusions 21′ as depicted in prior art FIG. 1. Although a steam turbine assembly 10 is illustrated, it should be understood that the following may apply to other turbine assemblies, including gas turbine assemblies.

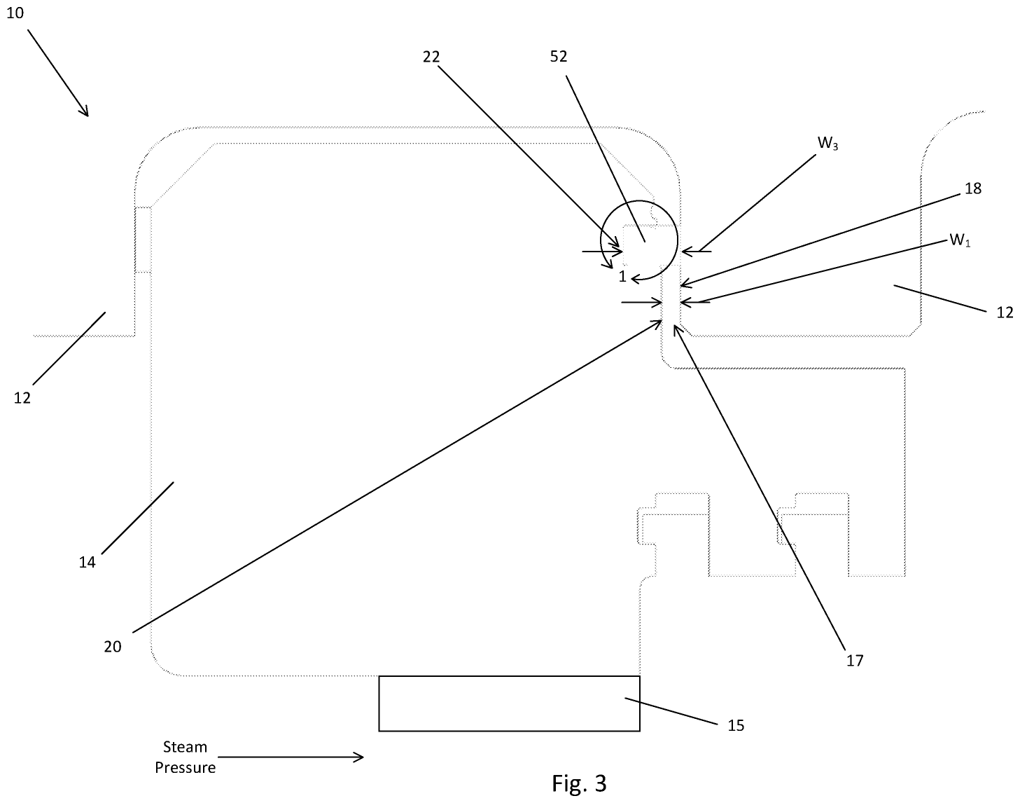

FIG. 3 is a cross-sectional schematic view of the steam turbine assembly 10 including an enlarged view depicting the relationship between the casing 12 and the diaphragm outer ring 14. In the exemplary embodiment, the casing 12 and the diaphragm outer ring 14 define a steam joint 17 that is within the steam flow path and is thus exposed to steam pressure. The steam joint 17 is defined by a surface 18 of the casing 12 and by a steam face 20 of the diaphragm outer ring 14 that is opposite the casing surface 18. The steam face 20 is the axial interface between the casing 12 and the diaphragm outer ring 14 that counteracts the axial pressure induced to the nozzle 15.

The axial width W₁ of the steam joint 17 can vary based upon a variety of factors, including but not limited to, the size of the steam turbine assembly 10, “dishing” of the diaphragm outer ring 14, and combinations thereof. The term “dishing” is used to describe creep deformation that may form within a web portion (not shown) of the diaphragm outer ring 14. In some instances, the axial width W₁ may have a range between about 0 inches “in” and about 0.25 in.

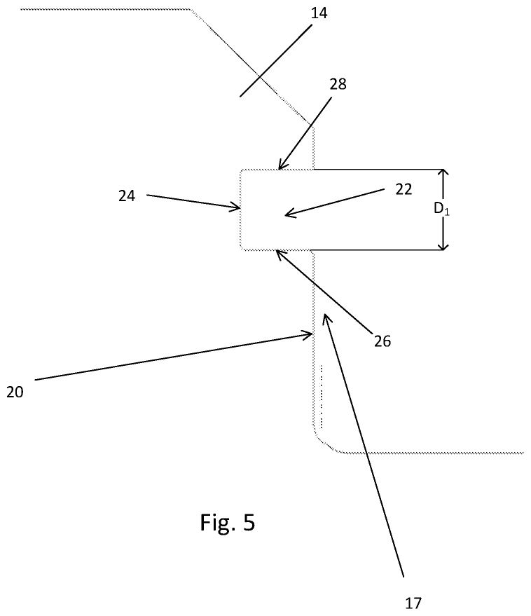

The diaphragm outer ring 14 includes a groove 22 defined therein that is formed relative to the casing 12. The groove 22 is open to the steam joint 17, as best seen in FIG. 5. The diaphragm outer ring 14 includes a first seal face 24 that is defined opposite the steam joint 17. The diaphragm outer ring 14 defines a second seal face 26 that is adjacent to the first seal face 24 and that is oriented opposite to the direction of the steam pressure flow. The diaphragm outer ring 14 also includes a third face 28 that is defined opposite the second seal face 26. The first seal face 24, the second seal face 26, and the third face 28 define, at least in part, the groove 22.

The groove 22 has an axial width W₂ that is measured between the steam face 20 of the diaphragm outer ring 14 and the opposite first seal surface 24 of the diaphragm outer ring 14, as best seen in FIG. E4. In some instances, the axial width W₂ may be between about 0.25 inches “in” to about 0.50 in. The groove 22 has an axial width W₃ that is measured between the casing surface 18 and the first seal surface 24 of the diaphragm outer ring 14. In some instances, the radial axial width W₃ may be between about 0.25 inches “in” to about 0.50 in.

In some instances, the groove 22 may be formed at the time of refurbishment to correct, for example, downstream deflection (dishing) at the shaft packing seal location 19. In other instances, the groove 22 may be formed before or after refurbishment, for example, when the steam turbine assembly 10 is originally manufactured.

In the exemplary embodiment, the steam turbine assembly 10 includes an inserted ring 52 that is sized and shaped to be inserted at least partially within the groove 22, either directly or indirectly. The inserted ring 52 have a standard-size wherein inserted rings 52 are manufactured with various incremental sizes that may be combined to increase the overall size. Similarly, portions of the inserted ring 52 may be removed to reduce the overall size. The term “size” is not limited to a diameter, but may also include, but is not limited to only including, the thickness, the width, and/or combinations thereof. The size may be measured relative to the inserted ring 52 and/or may be based on a radial dimension from an axis (e.g., a longitudinal axis).

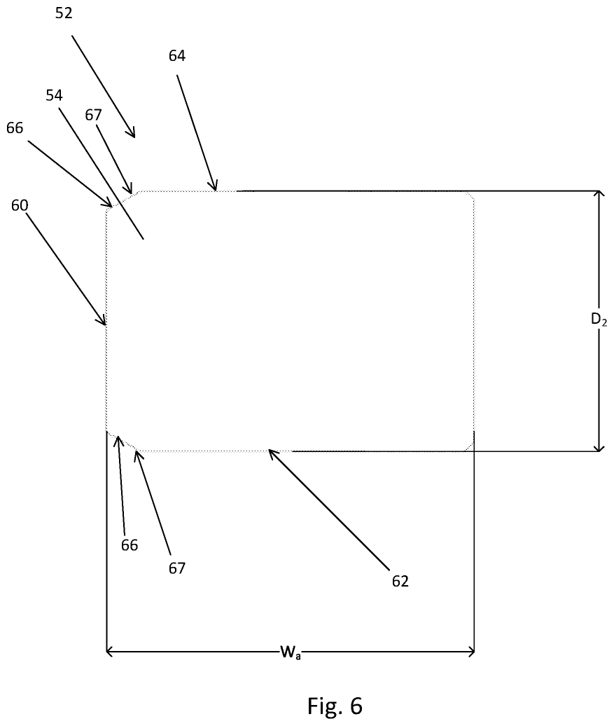

Referring to FIG. 6, the inserted ring 52 has a body 54 that has an axial width Wₐ. The axial width Wₐ of the inserted ring 52 may vary based on the application and may be incrementally sized. The desired axial width Wₐ of the body 54 of the inserted ring 52 may be selected prior to installation within the groove 22. The body 54 of the inserted ring 52 includes a first seal face 60 and a second seal face 62. The first and second seal faces 60 and 62 are adjacent to each other. The body 54 includes a third face 64 that is opposite the second seal face 62. The body 54 may also include a defined angled feature 66 in one or more corners 67 relative to the first seal face 60, the second seal face 62 and/or the third face 64.

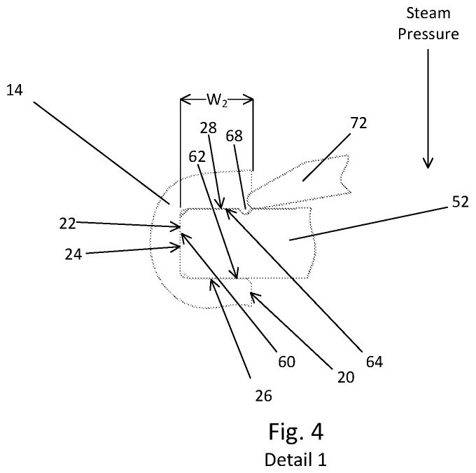

Referring to FIGS. 3, 4, and 7, the inserted ring 52 may be sized and shaped to be at least partially inserted within the groove 22 of the diaphragm outer ring 14. The distance D₁ between the second seal face 26 and the third face 28 of the groove 22 (see, e.g., FIG. 5) may be equal to or larger than a distance D₂ measured between the second seal face 62 and the third face 64 of the inserted ring 52 (see, e.g., FIG. 6). The distance D₂ between the second seal face 62 and the third face 64 of the inserted ring 52 may be about the same as, or smaller than, the distance D₁ between the second seal face 26 and the third face 28 of the groove 22. The inserted ring 52 may have an axial width Wₐ (see, e.g., FIG. 6) that is about the same as the axial width W₃ measured between the casing surface 18 and the first seal surface 24 of the diaphragm outer ring 14. In some embodiments, the inserted ring 52 has an axial width Wₐ that is about the same as the axial width W₃.

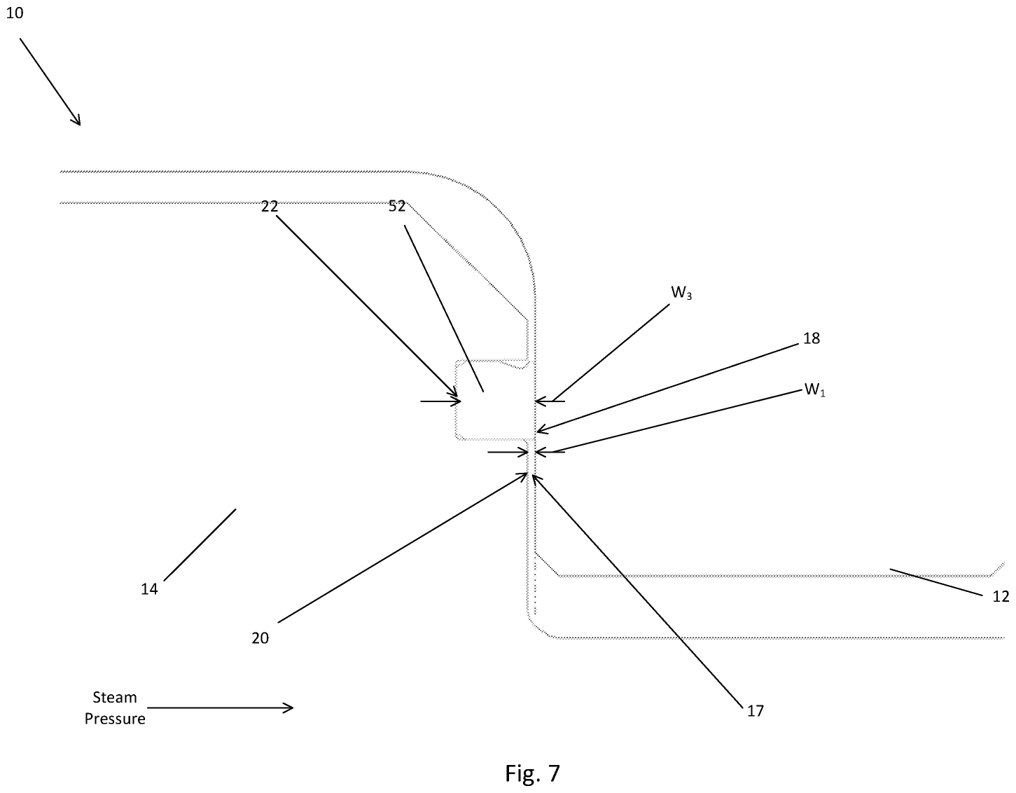

Referring to FIGS. 3 and 7, the axial width W₃ of the inserted ring 52 may vary based, in part, on the axial width W₁ of the steam joint 17. When installed, the inserted ring 52 at least partially contacts the first seal face 24 of the groove 22 such that a seal is formed between the first seal face 24 of the groove 22 and the first seal face 60 of the inserted ring 52. The inserted ring 52 also at least partially contacts the second seal face 26 of the groove 22 such that a seal is formed between the second seal face 26 of the groove and the second seal face 62 of the inserted ring 52. In some instances, the inserted ring 52 at least partially contacts the first seal face 24 and the second seal face 26 of the groove 22 such that a seal is formed between the first seal face 24 of the groove 22 and the first seal face 60 of the inserted ring 52, and between the second seal face 26 of the groove 22 and the second seal face 62 of the inserted ring 52.

The inserted ring 52 is inserted into the groove 22 and may be held in place using a variety of techniques, including but not limited to, peening, welding, adhesives, press fitting, and combinations thereof. In one embodiment and as shown in the figures, the inserted ring 52 is peened such that a portion 68 of the third face 28 of the diaphragm outer ring 14 is deformed in the direction of the third face 64 of the inserted ring 52. The deformed portion 68 at least partially retains the inserted ring 52 within the groove 22 of the diaphragm outer ring 14. In one embodiment, to create the peened area 68, a peening tool 72, such as, for example, a punch, an impact hammer, or the like, is directed at an angle relative to the steam face 20 of the diaphragm outer ring 14.

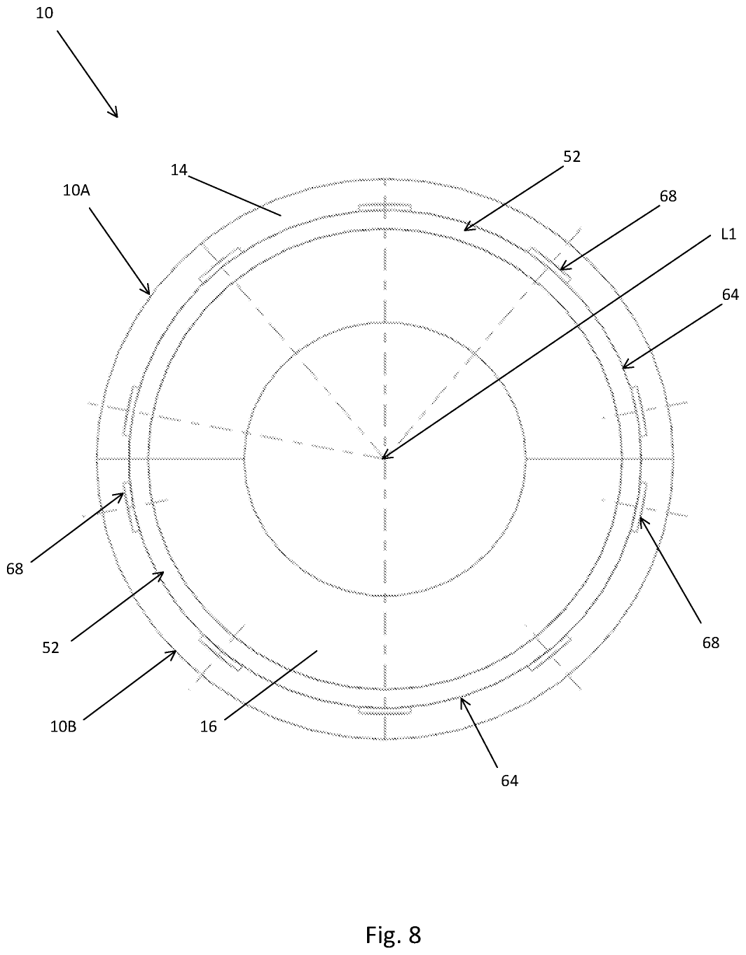

Although depicted with only one inserted ring 52, it should be understood that a plurality of inserted rings 52 may be used. For example, as shown in FIG. 8, in the exemplary embodiment, the steam turbine assembly 10 includes a plurality of inserted rings 52 that are positioned axially relative to a longitudinal axis (L₁). The plurality of inserted rings 52 may be selectively positioned at various circumferential locations relative to the longitudinal axis (L₁). For example, in one embodiment, a first half 10A of the steam turbine assembly 10 may include a first quantity of inserted rings 52, and a second half 10B of the steam turbine assembly 10 may include a second quantity of inserted rings 52. The first and second quantities of inserted rings 52 may be the same or may be different. As depicted, in the exemplary embodiment, the first and second quantities each include one (1) inserted ring 52. It should be understood that various quantities of inserted rings 52 may be used, without departing from the spirit/scope of this disclosure. For example, the first half 10A of the steam turbine assembly 10 may include two or more inserted rings 52 and the second half 10B of the steam turbine assembly 10 may include two or more inserted rings 52. The inserted ring(s) 52 may be held in place at one or more positions around the axis (L1), such as, a plurality of positions relative to the first half 10A and a plurality of positions relative to the second half 10B. For example, the deformed portion 68 at least partially retains the inserted ring 52 within the groove 22 of the diaphragm outer ring 14.

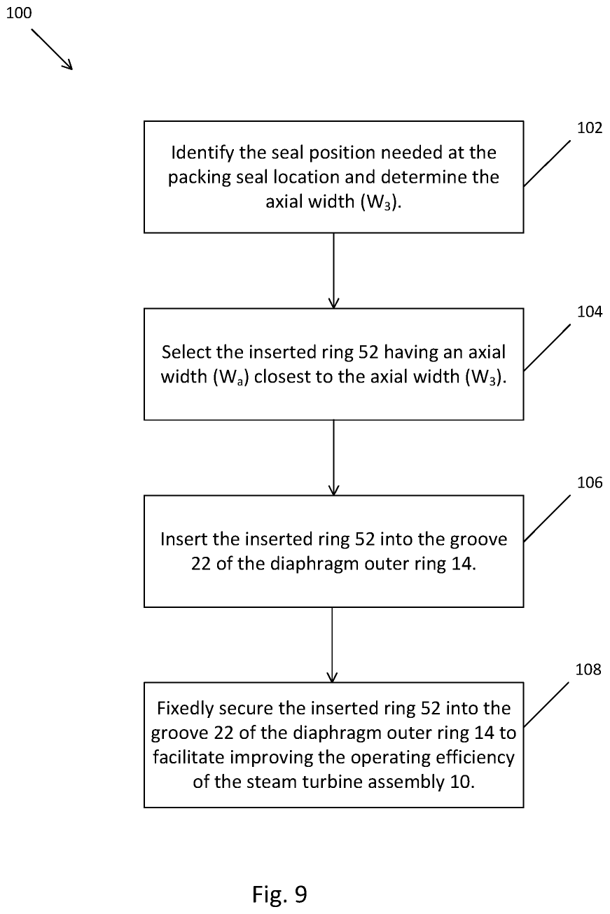

In operation (FIG. 9), in the exemplary method 100 of using the inserted ring 52, identify 102 the seal position required at the packing seal location relative to the packing ring 19 and identify the axial width W₃, which is measured between the surface 18 of the casing 12 and the first seal surface 24 of the diaphragm outer ring 14. The preferred seal position is based on the axial distance 27′ between the protrusion 21 of the packing ring 19 and the protrusions 25′ of the rotor 23′. The axial distance 27′ may vary based, in part, on the selected turbine. A corresponding inserted ring 52 is selected 104 that has an axial width Wₐ that is approximately the same as, or slightly smaller than the measured axial width W₃. The inserted ring 52 is then inserted 106 at least partially into the groove 22 defined within the diaphragm outer ring 14. The inserted ring 52 is fixedly secured 108 within the groove 22 of the diaphragm outer ring 14 to facilitate improving the operating efficiency of the steam turbine assembly 10. To ensure the inserted ring 52 remains in place during assembly of the steam turbine assembly 10, the inserted ring 52 is held in place, as described herein.

Referring to FIG. 6, the body 54 of the inserted ring 52 has an axial width Wₐ. The inserted ring 52 may be available in a variety of standard sizes, as defined at least partially by the axial width Wₐ. The variety of standard sizes may be incrementally sized such that the axial width Wₐ of the inserted ring is in a range of between about 0.15 inches to about 0.50 inches. The axial width Wₐ of the body 54 may vary and may depend, in part, on the overall size of the steam turbine assembly 10.

In some instances, the body 54 of the inserted ring 52 may include a plurality of inserts (not shown). Each insert (not shown) may include a tear line (not shown) that enables one or more of the inserts (not shown) to be selectively removed from the plurality of inserts (not shown). The tear line (not shown) may indicate an area of reduced material wherein at least one or more of the inserts (not shown) may be selectively separated from the plurality of inserts (not shown). In some instances, the tear line (not shown) is not visible, but rather is created by removing one or more of the inserts (not shown) from the plurality of inserts (not shown). For example, in some embodiments the tear line (not shown) is created by removing at least one insert (not shown) via bending, cutting, or the like. It should be understood, however, that alternatives to the tear line (not shown) may be used, without departing from the spirit/scope of this disclosure.

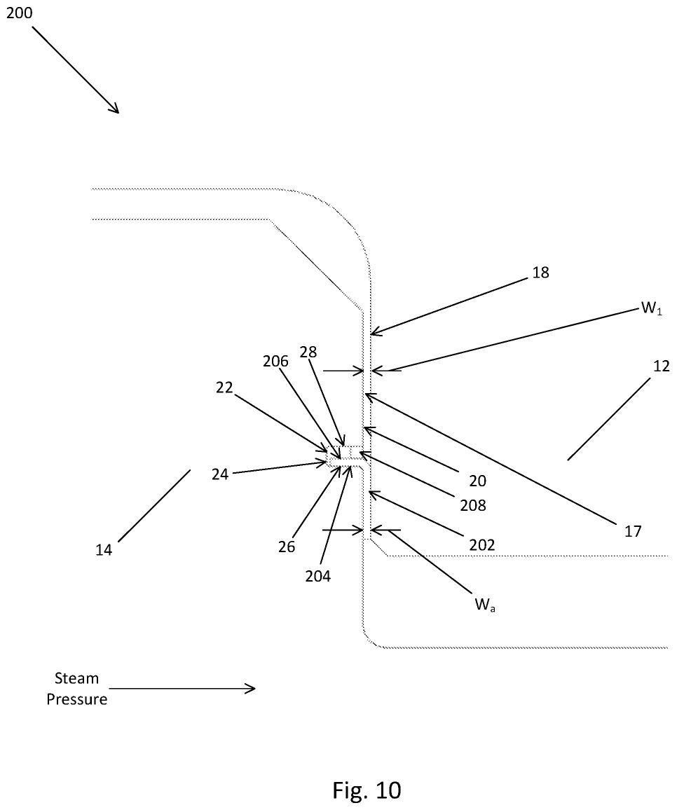

FIG. 10 is a cross-sectional view of an exemplary steam turbine assembly 200 including a casing 12 and a diaphragm outer ring 14 that is positioned relative to the casing 12. It should be understood that identical components are identified in FIG. 10 using the same reference numbers as used in FIGS. 2, 3, 5, and 7. The diaphragm outer ring 14 includes a groove 22 defined therein that is positioned relative to the casing 12. The groove 22 is open to a steam joint 17. The diaphragm outer ring 14 includes a first seal face 24 that is defined opposite the steam joint 17, and a second seal face 26 that is defined adjacent to the first seal face 24 and that is oriented oppositely to the direction of the steam flow. The diaphragm outer ring 14 includes a third face 28 that is defined opposite to the second seal face 26. As such, in the exemplary embodiment, the first seal face 24, the second seal face 26, and the third face 28 define, at least in part, the groove 22.

The steam turbine assembly 200 includes an inserted ring, for example, an angled inserted ring 202 that is sized and shaped to be at least partially inserted within the groove 22, either directly or indirectly. More specifically, in the exemplary embodiment, the angled inserted ring 202 is positioned at least partially within the groove 22 such that a first face 204 of the angled inserted ring 202 at least partially contacts the second seal face 26 of the diaphragm outer ring 14. The steam turbine assembly 200 includes a packing material 208 that is positioned relative to the angled inserted ring 202 and at least partially within the groove 22. The packing material 208 may be positioned between a second face 206 of the angled inserted ring 202 and the third face 28 of the diaphragm outer ring 14. The packing material 208 may include, but is not limited to only including, a caulking wire, and/or the packing material 208 may be peened and/or rolled into the groove 22 between the second face 206 of the angled inserted ring 202 and the third face 28 of the diaphragm outer ring 14.

The angled inserted ring 202 may also be positioned relative to the diaphragm outer ring 14 and the casing 12, for example, within the steam joint 17. For example, when installed, the angled seal 202 at least partially contacts the surface 18 of the casing 12 and the steam face 20 of the diaphragm outer ring 14. The angled inserted ring 202 may create a seal between the diaphragm outer ring 14 and the casing 12. The axial width Wₐ of the angled inserted ring 202 may be dimensioned such that the axial width Wₐ is approximately equal to the axial width (W₁) of the steam joint 17. The angled inserted ring 202 may be formed with a variety of axial widths Wₐ so as to accommodate a variety of steam joint widths Wₐ.

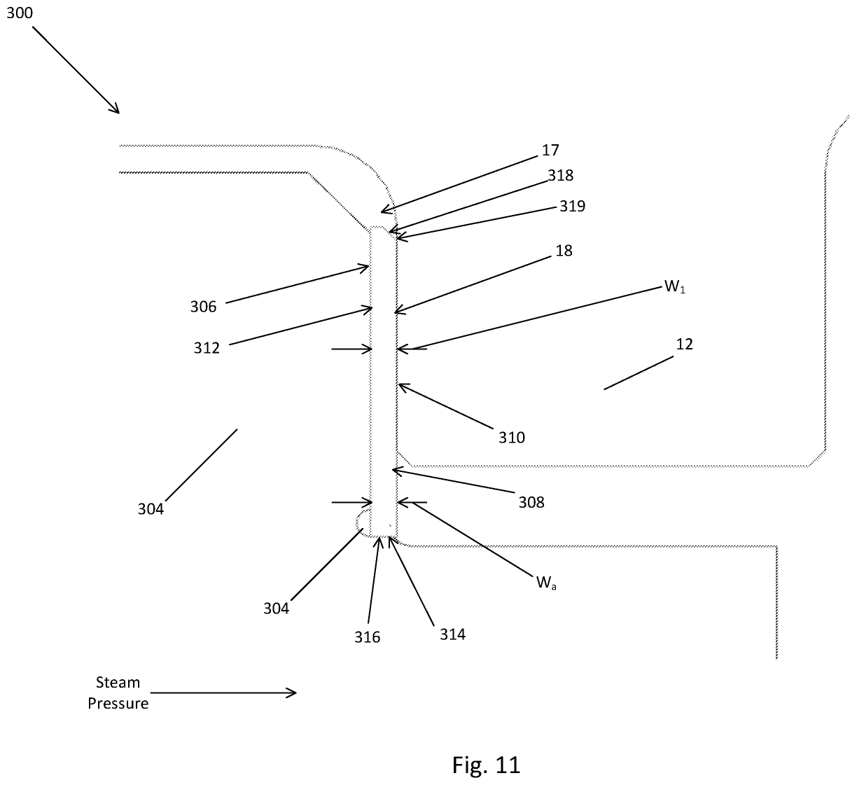

FIG. 11 is a cross-sectional view of an exemplary steam turbine assembly 300 including a casing 12 and a diaphragm outer ring 302 positioned relative to the casing 12. It should be understood that identical components are identified in FIG. 11 using the same reference numbers as used in FIGS. 2, 3, 5, and 7. It should also be understood that the diaphragm outer ring 302 is similar to the diaphragm outer ring 14, described above, but does not include a groove defined therein. Rather, in the exemplary embodiment, the casing 12 and the diaphragm outer ring 302 define a steam joint 17 that faces the steam flow pressure. The steam joint 17 is defined by a surface 18 of the casing 12 and a steam face 306 of the diaphragm outer ring 302 that is opposite the surface 18. The diaphragm outer ring 302 includes a radiused feature 304 defined on the steam face 306.

The steam turbine assembly 300 includes an inserted ring, for example, an inserted plate 308 that includes a first seal face 310 and a second seal face 312 that is opposite the first seal face 310. The inserted plate 308 is sized and shaped to be positioned at least partially in contact with the surface 18 of the casing 12 and with the steam face 306 of the diaphragm outer ring 14. The inserted plate 308 may include a third seal face 314 that is positioned at least partially in contact with a third face 316 of the diaphragm outer ring 302. The inserted plate 308 may create a seal between the diaphragm outer ring 14 and the casing 12. The axial width Wₐ of the inserted plate 308 may be dimensioned such that the axial width Wₐ is approximately equal to the axial width W₁ of the steam joint 17. The inserted plate 308 may be formed with a variety of axial widths Wₐ so as to accommodate a variety of different sized steam joints widths W₁. The inserted plate 308 may also include an angled feature 318 that is opposite from the third seal face 314. The angled feature 318 may assist with the insertion of the plate 308 with respect to the casing 12 and the diaphragm outer ring 302. A corner 319 of the inserted plate 308, adjacent to the third seal face 314, may be positioned at least partially within the radiused feature 304 of the diaphragm outer ring 302.

At least some of the advantages of the systems described herein, over the prior art, include, at least: (i) selective adjustments of the axial position of the inserted ring/plate; (ii) incremental adjustments of the inserted ring/plate for ease of repair; (iii) reduced downtime of the rotating machinery; and (iv) reduced analysis required to select an appropriate inserted ring/plate based on a determined axial width between components of the rotating machinery.

The systems described herein enable the steam turbine assembly 10, 200, and 300 to be refurbished, thereby reducing the extent the system is not fully operational and, in some cases, entirely removed from use. In some instances, for example in the power generation industry, refurbishment of the steam turbine assembly 10, 200, and 300 may reduce the extent of an outage and save the user and/or the energy provider money based, in some part, on the extent of the outage.

The above description is meant to be exemplary only, and one skilled in the art will recognize that changes may be made to the embodiments described without departing from the scope of the invention disclosed. Modifications, which fall within the scope of the present invention, will be apparent to those skilled in the art, in light of a review of this disclosure, and such modifications are intended to fall within the appended claims. The systems described herein are not limited to the specific embodiments described herein, but rather portions of the various systems may be utilized independently and separately from other systems described herein.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

Further aspects of the invention are provided by the subject matter of the following clauses:

Clause 1. An inserted ring for a turbine assembly, wherein the turbine assembly includes a casing and a turbine stationary component radially inward from the casing such that the casing and the turbine stationary component define a steam joint therebetween, the inserted ring including a first face positioned adjacent to the casing; and a second face positioned in close proximity to the turbine stationary component such that the second face is spaced a distance from and opposite to the first face, wherein the inserted ring has an axial width defined by the first and second faces.

Clause 2. The inserted ring for a turbine assembly according to clause 1, wherein the inserted ring includes a plate that is oriented within the turbine assembly such that the first face at least partially contacts the casing, and such that the second face at least partially contacts the turbine stationary component.

Clause 3. The inserted ring for a turbine assembly according to any of the proceeding clauses, wherein the turbine stationary component includes a groove defined therein that opens towards the steam joint, wherein the inserted ring is sized to be inserted at least partially within the groove of the turbine stationary component.

Clause 4. The inserted ring for a turbine assembly according to any of the proceeding clauses, wherein the turbine stationary component includes a first seal face opposite from the portion of the groove that opens towards the steam joint, wherein the second face of the inserted ring at least partially contacts the first seal face of the turbine stationary component.

Clause 5. The inserted ring for a turbine assembly according to any of the proceeding clauses, wherein the inserted ring defines a body that has an axial width Wₐ that is in a range between about 0.15 inches and about 0.50 inches.

Clause 6. The inserted ring for a turbine assembly according to any of the proceeding clauses, wherein the turbine stationary component is selected from the group comprising a diaphragm outer ring, a packing head, a packing ring, a packing carrier, an oil deflector, and combinations thereof.

Clause 7. The inserted ring for a turbine assembly according to any of the proceeding clauses, wherein the turbine stationary component defines a second seal face that is adjacent to the first seal face, wherein the second face of the inserted ring at least partially contacts the first seal face of the turbine stationary component and a third face of the inserted ring at least partially contacts the second seal face of the turbine stationary component.

Clause 8. The inserted ring for a turbine assembly according to any of the proceeding clauses, wherein the turbine assembly has a longitudinal axis, wherein a plurality of inserted rings are circumferentially spaced relative to the longitudinal axis and coupled to the turbine stationary component.

Clause 9. A turbine assembly including a casing and a turbine stationary component radially inward from the casing such that the casing and the turbine stationary component define a steam joint therebetween, the turbine stationary component defines a groove open to the steam joint, the turbine stationary component defines a first seal face within the groove and opposite from the portion open to the steam joint, and a second seal face within the groove and adjacent to the first seal face, the turbine assembly including an inserted ring, the inserted ring including: a body including a first face, a second face adjacent to the first face, and a third face opposite from the first face, wherein the first face is positioned in close proximity to the first seal face of the turbine stationary component, the second face is positioned in close proximity to the second seal face of the turbine stationary component, and the third face is positioned in close proximity to the casing.

Clause 10. The turbine assembly according to any of the proceeding clauses, wherein the body of the inserted ring has an axial width Wₐ in a range between about 0.25 inches to about 0.50 inches.

Clause 11. The turbine assembly according to any of the proceeding clauses, wherein the body of the inserted ring has an axial width Wₐ that is in a range between about 0.15 inches and about 0.50 inches.

Clause 12. The turbine assembly according to any of the proceeding clauses, wherein the inserted ring is fixedly secured within the groove of the turbine stationary component.

Clause 13. The turbine assembly according to any of the proceeding clauses, wherein the steam turbine assembly has a longitudinal axis, wherein a plurality of inserted rings are spaced relative to the longitudinal axis and coupled to the turbine stationary component.

Clause 14. The turbine assembly according to any of the proceeding clauses, wherein the body of the inserted ring is angled such that the third face of the body is longer than the first face.

Clause 15. The turbine assembly according to any of the proceeding clauses further including a packing material positioned in close proximity to and opposite from the second face of the inserted ring.

Clause 16. The turbine assembly according to any of the proceeding clauses, wherein the inserted ring is an inserted plate that is positioned within the steam joint and in contact with both the casing and the turbine stationary component.

Clause 17. A method for selectively positioning an inserted ring relative to a turbine assembly that includes a casing and a turbine stationary component positioned radially inwardly from the casing such that the casing and the turbine stationary component define a steam joint therebetween, the method including: identifying a seal position required at a packing seal location and identifying an axial width defined between a first seal face of the turbine stationary component and a radially inner surface of the casing; selecting an inserted ring having an axial width that is approximately the same as the axial width identified between the first seal face of the turbine stationary component and the radially inner surface of the casing; inserting the inserted ring at least partially within a groove defined circumferentially within the turbine stationary component; and fixedly securing the inserted ring within the turbine stationary component groove to facilitate improving the operating efficiency of the turbine assembly.

Clause 18. The method according to any of the proceeding clauses, wherein selecting an inserted ring further includes selecting an inserted ring that includes a body that is positioned relative to the radially inner surface of the casing.

Clause 19. The method according to any of the proceeding clauses, wherein selecting an inserted ring further includes selecting an inserted ring that includes a body that has an axial width Wₐ that is in a range between about 0.15inches and about 0.50 inches.

Clause 20. The method according to any of the proceeding clauses, wherein selecting an inserted ring further includes selecting an inserted ring that comprises a first face and a second face adjacent to the first face, wherein the first face of the inserted ring is positioned in close proximity to the first seal face of the turbine stationary component and the second face of the inserted ring is positioned in close proximity to a third seal face adjacent to the first seal face of the turbine stationary component. the first and second faces of the inserted ring combine to produce a seal relative to the turbine stationary component.

While the invention has been described in terms of various specific embodiments, those skilled in the art will recognize that the invention can be practiced with modification within the spirit and scope of the claims.

What is claimed is:

1. An inserted ring for a turbine assembly, wherein the turbine assembly comprises a casing and a turbine stationary component radially inward from the casing such that the casing and the turbine stationary component define a steam joint therebetween, the inserted ring comprising:
a first face positioned adjacent to the casing; and
a second face positioned in close proximity to the turbine stationary component such that the second face is spaced a distance from and opposite to the first face, wherein the inserted ring has an axial width defined by the first and second faces.

2. The inserted ring for a turbine assembly according to claim 1, wherein the inserted ring comprises a plate that is oriented within the turbine assembly such that the first face at least partially contacts the casing, and such that the second face at least partially contacts the turbine stationary component.

3. The inserted ring for a turbine assembly according to claim 1, wherein the turbine stationary component comprises a groove defined therein that opens towards the steam joint, wherein the inserted ring is sized to be inserted at least partially within the groove of the turbine stationary component.

4. The inserted ring for a turbine assembly according to claim 3, wherein the turbine stationary component comprises a first seal face opposite from a portion of the groove that opens towards the steam joint, wherein the second face of the inserted ring at least partially contacts the first seal face of the turbine stationary component.

5. The inserted ring for a turbine assembly according to claim 1, wherein the inserted ring defines a body that has an axial width Wₐ that is in a range between about 0.15 inches and about 0.50 inches.

6. The inserted ring for a turbine assembly according to claim 1, wherein the turbine stationary component is selected from a group comprising a diaphragm outer ring, a packing head, a packing ring, a packing carrier, an oil deflector, and combinations thereof.

7. The inserted ring for a turbine assembly according to claim 4, wherein the turbine stationary component defines a second seal face that is adjacent to the first seal face, wherein the second face of the inserted ring at least partially contacts the first seal face of the turbine stationary component and a third face of the inserted ring at least partially contacts the second seal face of the turbine stationary component.

8. The inserted ring for a turbine assembly according to claim 1, wherein the turbine assembly has a longitudinal axis, wherein a plurality of inserted rings are circumferentially spaced relative to the longitudinal axis and coupled to the turbine stationary component.

9. A turbine assembly comprising a casing and a turbine stationary component radially inward from the casing such that the casing and the turbine stationary component define a steam joint therebetween, the turbine stationary component defines a groove open to the steam joint, the turbine stationary component defines a first seal face within the groove and opposite from the portion open to the steam joint, and a second seal face within the groove and adjacent to the first seal face, the turbine assembly comprising an inserted ring, the inserted ring comprising:
a body including a first face, a second face adjacent to the first face, and a third face opposite from the first face, wherein the first face is positioned in close proximity to the first seal face of the turbine stationary component, the second face is positioned in close proximity to the second seal face of the turbine stationary component, and the third face is positioned in close proximity to the casing.

10. The turbine assembly according to claim 9, wherein the body of the inserted ring has an axial width Wₐ in a range between about 0.25 inches to about 0.50 inches.

11. The turbine assembly according to claim 9, wherein the body of the inserted ring has an axial width Wₐ that is in a range between about 0.15 inches and about 0.50 inches.

12. The turbine assembly according to claim 9, wherein the inserted ring is fixedly secured within the groove of the turbine stationary component.

13. The turbine assembly according to claim 9, wherein the turbine assembly has a longitudinal axis, wherein a plurality of inserted rings are spaced relative to the longitudinal axis and coupled to the turbine stationary component.

14. The turbine assembly according to claim 9, wherein the body of the inserted ring is angled such that the third face of the body is longer than the first face.

15. The turbine assembly according to claim 9 further comprising a packing material positioned in close proximity to and opposite from the second face of the inserted ring.

16. The turbine assembly according to claim 9, wherein the inserted ring is an inserted plate that is positioned within the steam joint and in contact with both the casing and the turbine stationary component.

17. A method for selectively positioning an inserted ring relative to a turbine assembly that includes a casing and a turbine stationary component positioned radially inwardly from the casing such that the casing and the turbine stationary component define a steam joint therebetween, the method comprising:
identifying a seal position required at a packing seal location and identifying an axial width defined between a first seal face of the turbine stationary component and a radially inner surface of the casing;
selecting an inserted ring having an axial width that is approximately the same as the axial width identified between the first seal face of the turbine stationary component and the radially inner surface of the casing;
inserting the inserted ring at least partially within a groove defined circumferentially within the turbine stationary component; and
fixedly securing the inserted ring within the turbine stationary component groove to facilitate improving an operating efficiency of the turbine assembly.

18. The method according to claim 17, wherein selecting an inserted ring further comprises selecting an inserted ring that comprises a body that is positioned relative to the radially inner surface of the casing.

19. The method according to claim 17, wherein selecting an inserted ring further comprises selecting an inserted ring that comprises a body that has an axial width Wₐ that is in a range between about 0.15 inches and about 0.50 inches.

20. The method according to claim 17, wherein selecting an inserted ring further comprises selecting an inserted ring that comprises a first face and a second face adjacent to the first face, wherein the first face of the inserted ring is positioned in close proximity to the first seal face of the turbine stationary component and the second face of the inserted ring is positioned in close proximity to a third seal face adjacent to the first seal face of the turbine stationary component, the first and second faces of the inserted ring combine to produce a seal relative to the turbine stationary component.
